(19) United States
(12) Patent Application Publication
(10) Pub. No.: US 2004/0091191 A1
(43) Pub. Date: May 13, 2004

(54) Self-cooling ball bearing

(76) Inventor: George Ganimian, East Boston, MA (US)

Correspondence Address: Lambert & Associates, 92 State Street, Boston, MA, 02109-2004, US

(21) Appl. No.: 10/290,987

(22) Filed: Nov. 8, 2002

(51) Int. Cl. F16C 33/34

(52) U.S. Cl. 384/567

(57) ABSTRACT

A ball bearing having self-cooling properties is provided. The ball bearing is comprised of a bearing element having at least one hollow region inside of the bearing element to serve as an aid in heat dissipation and self-cooling as ball bearing heats up during normal operation. The hollow regions could be embodied in primary extension cavities, which are in fluid communication with an axial bore running through the bearing element. The hollow regions could also be embodied in at least one main cooling bore, which could be in fluid communication with at least one secondary extension cavity.

### BACKGROUND OF INVENTION

The present invention relates to ball bearings. Specifically it relates to ball bearings which may overheat during normal operation.

Bearing elements, such as ball bearings, are well known. However, prior art ball bearings do not provide for ball bearings that are self-cooling and resistant to overheating.

The following prior art is known to Applicant: U.S. Pat. No. 636,757 to Carraway discloses a ball caster. Carraway's device is aimed at improving the mounting of the structure of the ball.

U.S. Pat. No. 755,406 to Spengler discloses a bearing for balls rolling on two rails. Spengler's device is aimed at a substitute for the wheels and axles of devices used on the rails.

U.S. Pat. No. 5,071,261 to Stuve discloses an earthquake bearing. Stuve's device is aimed at a compact earthquake bearing with compliant, progressive damping in both the horizontal and vertical directions.

U.S. Pat. No. 5,074,678 to Eberle discloses a process for controlling the rolling of rolling elements within a linear guide. Eberle's device is aimed at a process for controlling the rolling of the rolling elements such that frictional resistance is minimized.

However, none of the above-discussed prior art references disclose a ball bearing having self-cooling properties.

What is needed is a ball bearing that will resist overheating even in those ball bearings that are of a relatively large size.

### SUMMARY OF THE INVENTION

The disclosed device is aimed at providing a ball bearing that can resist overheating during normal operation. The ball bearing is comprised of a spherical bearing element having at least one hollow region located within the bearing element which construction is believed to aid in the prevention of overheating of the bearing element. The bearing element may have an axial bore running through it, wherein a positioning rod can be passed through the axial bore in order to keep the ball bearing in place.

The axial bore may have at least one primary extension cavity located within the bearing element, wherein the extension cavity has an open end and a closed end, and wherein the open end of the primary extension cavity is in liquid communication with the axial bore.

At least one hollow region could be a main cooling bore running through the bearing element, wherein the main cooling bore has two open ends located on a surface of the bearing element.

The main cooling bore may have at least one secondary extension cavity located within the bearing element, wherein the secondary extension cavity has an open end and a closed end, and wherein the open end of the secondary extension cavity is in liquid communication with the main cooling bore.

Therefore, it is the object of the present invention to provide a ball bearing having self-cooling properties.

It is another object of the present invention to provide a ball bearing having self-cooling properties in the ball bearing of a relatively large size.

It is yet another object of the present invention to provide a ball bearing having self-cooling properties, which could be easily manufactured.

These and other features, aspects, and advantages of the present invention will become better understood with reference to the following description, appended claims and accompanying drawings.

### BRIEF DESCRIPTION OF DRAWINGS

FIG. 1 depicts the cross-sectional view of the bearing element of the present invention.

FIG. 2 depicts the front view of the bearing element of the present invention.

### DETAILED DESCRIPTION OF THE INVENTION

This invention is aimed at providing a ball bearing that is resistant to overheating. The ball bearing is comprised of a spherical bearing element having at least one hollow region located within the bearing element, wherein the hollow regions are believed to aid in the self-cooling of the bearing element.

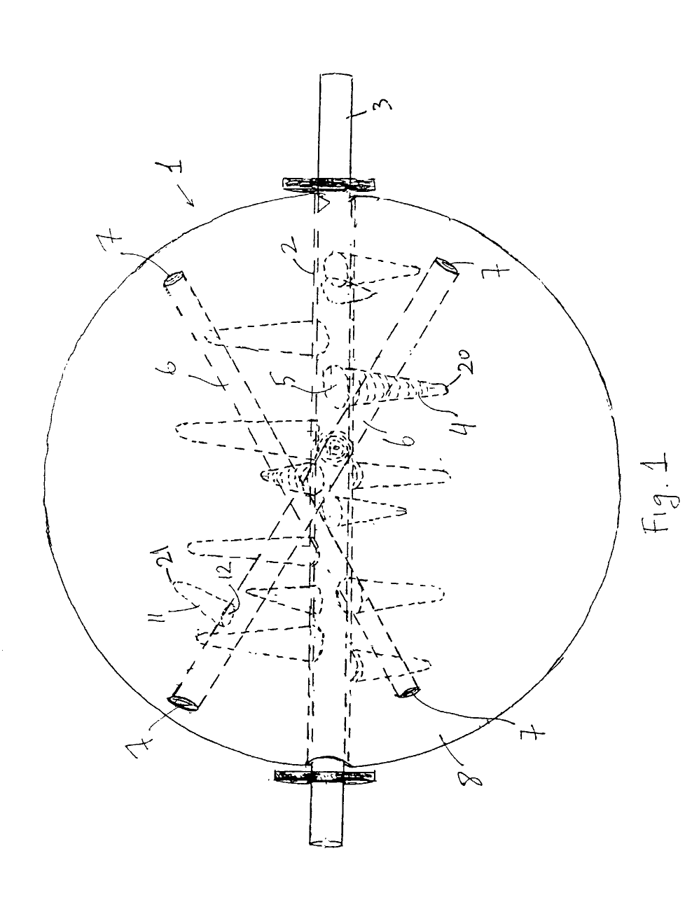

One of the embodiments of the disclosed ball bearing is shown in a cross sectional view in FIG. 1. The ball bearing of FIG. 1 is comprised of a bearing element 1 with an axial bore 2 running through it. A positioning rod 3 could be placed through the axial bore 2.

At least one hollow region located within the bearing element 1 could be a primary extension cavity 4, wherein the primary extension cavity 4 has an open end 5 and a closed end 20, and wherein the open end 5 of the primary extension cavity 4 is in liquid communication with the axial bore 2.

The primary extension cavity 4 could have a conical shape, as depicted in FIG. 1, wherein the open end 5 of the primary extension cavity is wider than the closed end 20 of the primary extension cavity 4, and wherein the primary extension cavity 4 is positioned substantially perpendicularly with respect to the axial bore 2.

At least one hollow region located within the bearing element 1 could also be a main cooling bore 6 running through the bearing element 1, wherein the main cooling bore 6 has two open ends 7 located on the surface 8 of the bearing element 1.

The main cooling bore 6 could have at least one secondary extension cavity 11 located within the bearing element 1, wherein the secondary extension cavity 11 has an open end 12 and a closed end 21, and wherein the open end 12 of the secondary extension cavity 11 is in liquid communication with the main cooling bore 6.

The secondary extension cavity 11 could have a conical shape, as shown in FIG. 1, wherein the open end 12 of the secondary extension cavity 11 is wider than the closed end 21 of the secondary extension cavity 11, and wherein the secondary extension cavity 11 is positioned substantially perpendicularly with respect to the main cooling bore 6.

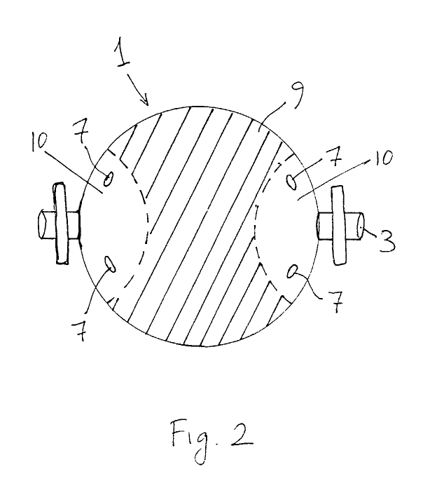

FIG. 2 depicts a front view of one of the embodiments of the bearing element 1. The bearing element 1 may have a bearing area 9 located on its surface 8 which bearing area 9 may come into physical contact with parts of a device within which the bearing element 1 is incorporated.

The surface 8 of the bearing element 1 could have at least two oppositely positioned non-bearing areas 10 wherein the non-bearing areas 10 are areas of the surface 8 of the bearing element 1 which do not come into physical contact with parts of a device within which the bearing element 1 is incorporated. The two open ends 7 of the main cooling bore 6 could be oppositely located on the oppositely positioned non-bearing areas 10 of the bearing element 1. This arrangement serves to prevent contact between open ends 7 and parts of a device within which the bearing element 1 is incorporated.

It will be further understood that the embodiment described herein is merely exemplary, and that a person skilled in the art may make variations and modifications without departing from the spirit and scope of the invention. All such variations and modifications are intended to be included within the scope of the appended claims.

What is claimed is:

1. A ball bearing, comprising:
a spherical bearing element having at least one hollow region located within the bearing element.

2. The ball bearing of claim 1, further comprising:
an axial bore running through the bearing element, whereby a positioning rod can be passed through the axial bore.

3. The ball bearing of claim 2, wherein:
the at least one hollow region is a primary extension cavity, wherein the primary extension cavity has an open end and a closed end, and wherein the open end of the primary extension cavity is in liquid communication with the axial bore.

4. The ball bearing of claim 3, wherein:
the primary extension cavity has a conical shape, wherein the open end of the primary extension cavity is wider than the closed end of the primary extension cavity, and wherein the primary extension cavity is positioned substantially perpendicularly with respect to the axial bore.

5. The ball bearing of claim 1, wherein:
the at least one hollow region is a main cooling bore running through the bearing element, wherein the main cooling bore has two open ends located on a surface of the bearing element.

6. The ball bearing of claim 5, wherein:
the surface of the bearing element has a bearing area, wherein the bearing area is an area of the surface of the bearing element which may come into physical contact with parts of a device within which the bearing element is incorporated;
the surface of the bearing element has at least two oppositely positioned non-bearing areas, wherein the non-bearing areas are areas of the surface of the bearing element which do not come into physical contact with parts of a device within which the bearing element is incorporated; and
the two open ends of the main cooling bore are oppositely located on the oppositely positioned non-bearing areas of the bearing element.

7. The ball bearing of claim 5, wherein:
the main cooling bore has at least one secondary extension cavity located within the bearing element, wherein the secondary extension cavity has an open end and a closed end, and wherein the open end of the secondary extension cavity is in liquid communication with the main cooling bore.

8. The ball bearing of claim 7, wherein:
the secondary extension cavity has a conical shape, wherein the open end of the secondary extension cavity is wider than the closed end of the secondary extension cavity, and wherein the secondary extension cavity is positioned substantially perpendicularly with respect to the main cooling bore.

9. A ball bearing, comprising:
a spherical bearing element having:
an axial bore running through the bearing element, whereby a positioning rod can be passed through the axial bore; and
at least one hollow region located within the bearing element.

10. The ball bearing of claim 9, wherein:
the at least one hollow region is a main cooling bore running through the bearing element, wherein the main cooling bore has two open ends located on a surface of the bearing element.

11. The ball bearing of claim 10, wherein:
the surface of the bearing element has a bearing area, wherein the bearing area is an area of the surface of the bearing element which may come into physical contact with parts of a device within which the bearing element is incorporated;
the surface of the bearing element has at least two oppositely positioned non-bearing areas, wherein the non-bearing areas are areas of the surface of the bearing element which do not come into physical contact with parts of a device within which the bearing element is incorporated; and
the two open ends of the main cooling bore are oppositely located on the oppositely positioned non-bearing areas of the bearing element.

12. The ball bearing of claim 9, wherein:
the at least one hollow region is a primary extension cavity, wherein the primary extension cavity has an open end and a closed end, and wherein the open end of the primary extension cavity is in liquid communication with the axial bore.

13. The ball bearing of claim 12, wherein:
the primary extension cavity has a conical shape, wherein the open end of the primary extension cavity is wider than the closed end of the primary extension cavity, and wherein the primary extension cavity is positioned substantially perpendicularly with respect to the axial bore.

14. The ball bearing of claim 10, wherein:
the main cooling bore has at least one secondary extension cavity located within the bearing element, wherein the secondary extension cavity has an open end and a closed end, and wherein the open end of the secondary extension cavity is in liquid communication with the main cooling bore.

15. The ball bearing of claim 14, wherein:
the secondary extension cavity has a conical shape, wherein the open end of the secondary extension cavity is wider than the closed end of the secondary extension cavity, and wherein the secondary extension cavity is positioned substantially perpendicularly with respect to the main cooling bore.

16. A ball bearing, comprising:
a spherical bearing element having:
an axial bore running through the bearing element, whereby a positioning rod can be passed through the axial bore, wherein the axial bore has at least one primary extension cavity located within the bearing element, wherein the extension cavity has an open end and a closed end, and wherein the open end of the primary extension cavity is in liquid communication with the axial bore,
at least one main cooling bore running through the bearing element, wherein the main cooling bore has two open ends located on a surface of the bearing element.

17. The ball bearing of claim 16, wherein:
the primary extension cavity has a conical shape, wherein the open end of the primary extension cavity is wider than the closed end of the primary extension cavity, and wherein the primary extension cavity is positioned substantially perpendicularly with respect to the axial bore.

18. The ball bearing of claim 16, wherein:
the surface of the bearing element has a bearing area, wherein the bearing area is an area of the surface of the bearing element which may come into physical contact with parts of a device within which the bearing element is incorporated;
the surface of the bearing element has at least two oppositely positioned non-bearing areas, wherein the non-bearing areas are areas of the surface of the bearing element which do not come into physical contact with parts of a device within which the bearing element is incorporated; and
the two open ends of the main cooling bore are oppositely located on the oppositely positioned non-bearing areas of the bearing element.

19. The ball bearing of claim 16, wherein:
the main cooling bore has at least one secondary extension cavity located within the bearing element, wherein the secondary extension cavity has an open end and a closed end, and wherein the open end of the secondary extension cavity is in liquid communication with the main cooling bore.

20. The ball bearing of claim 19, wherein:
the secondary extension cavity has a conical shape, wherein the open end of the secondary extension cavity is wider than the closed end of the secondary extension cavity, and wherein the secondary extension cavity is positioned substantially perpendicularly with respect to the main cooling bore.
